(19) United States
(12) Patent Application Publication
(10) Pub. No.: US 2014/0073495 A1
(43) Pub. Date: Mar. 13, 2014

(54) Cable Attachment For Exercise Machine

(71) Applicants: Keith Anderson, San Gabriel, CA (US); Karl Anderson, Glendora, CA (US)

(72) Inventors: Keith Anderson, San Gabriel, CA (US); Karl Anderson, Glendora, CA (US)

(73) Assignees: Grace Premier Fitness and Wellness Products, Inc., Vancouver, WA (US); Ace Specialty, Inc., Rosemead, CA (US)

(21) Appl. No.: 13/845,016

(22) Filed: Mar. 17, 2013

Related U.S. Application Data
(60) Provisional application No. 61/699,202, filed on Sep. 10, 2012.

(51) Int. Cl. A63B 21/00; F16G 11/00

(52) U.S. Cl. CPC A63B 21/1403; F16G 11/00
USPC 482/139; 24/129 R; 24/128

(57) ABSTRACT

A cable attachment that permits the strap of an exercise machine to be replaced independently of the machine's handle without the need for sewing machines or special tools such as crimping devices comprises a body having three juncture points arranged in a generally triangular relationship, the first point being near its top to accommodate the body's attachment to the cable of the exercise machine, the other two juncture points lying below the first point and separated from each other by the center section of the body. The two lower junction points are configured to securely accommodate a removably-coupled handle-coupling strap, and are the locations to which the straps can be secured, preferably with a suitable knot. The two lower juncture points are configured to resist lateral slippage of the straps in order to laterally stabilize the load against which the user is working, and to accommodate knots having excellent holding strength.

### BACKGROUND

In the fitness industry, cable attachments are devices that couple a handle or other user-contacting surface member to the cable of a of a cable machine.

Cable machines are used in weight training, and typically comprise a frame and weight stack. The cable couples the weight stacks to a handle gripped by the user, and typically extends around one or more pulleys positioned between the weight stack and handle. It can be noted that cable machines may use other resistance-generating components than weight plate stacks, such as resilient resistance members, pneumatic or hydraulic pistons and the like. It should be understood that the description of weight plate stacks is merely exemplary, and that there is no intention to limit the invention to the use of cable machines employing weight plates as a source of resistance. p Cable machines allow the user to exercise different muscle groups by pulling or pushing against the resistance at the other end of the cable. A variety of exercises can typically be performed on the apparatus, with many of the exercises requiring, or at least lending themselves to, the use of different types of handles, sleeves, ropes, bands and/or other user-contacting components (hereinafter collectively referred to as “handles” for the sake of brevity).

Traditionally, the manufacturers and users of cable machines have sought configurations permitting handles to be changed quickly without sacrificing the need to securely and safely couple the handles to the cable.

Known cable attachments are typically made of solid steel and have welded tabs with a hole in the tab for attachment of with a snap or caribiner affixed to the cable machine's cable.

Other known cable attachments use a strap sewn to a piece of hardware, such a “D”-ring or “O”-ring to which the cable is attached. The straps wear out, however, causing the entire device to be thrown out since the user and/or gym is highly unlikely to engage in the labor-intensive effort of cutting the stitching, replacing the straps, and re-sewing the straps to securely couple to the ring. Moreover, the user or gym is unlikely to have a sewing machine that can appropriately sew the straps to the ring.

### SUMMARY

The invention is a cable attachment for an exercise machine that permits the strap, which couples the handle gripped by the user to the machine's cable, to be replaced independently of the handle without the need for sewing machines or special tools such as crimping devices.

Briefly, the cable attachment comprises a body having three juncture points arranged in a generally triangular relationship, the first point being relatively distal to the handle to accommodate the body's attachment to the cable of the exercise machine, the other two juncture points being relatively proximal to the handle and separated from each other by the center section of the body, said other two junction points being configured to securely accommodate a removably-coupled handle-coupling strap.

Preferably, the first juncture point is a hole that accommodates the body's attachment to the cable of the machine. The other two juncture points lie below the hole, separated from each other by the center section of the body, and are the locations to which the straps can be secured, preferably with a suitable knot. The two lower juncture points are configured to resist lateral slippage of the straps in order to laterally stabilize the load against which the user is working. (It should be understood that the terms “top”, “bottom”, “upper”, “lower”, “above” and “below” are relative, and depend on the orientation of the handle and cable in space; an assumption about the orientation and the consequential relative locations of the juncture points is made herein and in the following Description of the Preferred Embodiment for the sake of simplicity, and not by way of limitation.)

The two proximal juncture points are further configured to accommodate knots in the strap that have excellent holding strength. The preferred knot is a cow hitch type knot because it has excellent holding strength, does not slip easily, and is easily undone when the strap needs to be replaced without replacing the handle. The ends of the straps can be clamped, and it is preferable to do so for additional security.

These and other details concerning the invention will be apparent from the following description of the preferred embodiment, of which the drawings form a part.

### DESCRIPTION OF THE DRAWING

FIG. 1 is a front elevation view of a typical handle coupled to a preferred embodiment of a cable attachment constructed in accordance with the invention.

FIG. 2A is a front elevation view of the cable attachment illustrated in FIG. 1;

FIG. 2B illustrates the preferred dimensions and radii of curvatures of the cable attachment body of FIG. 2A;

FIGS. 3A-B illustrate the formation of the preferred knot used to couple straps to the cable attachment body of FIG. 2A;

FIG. 4 is a front elevation view of an alternative cable attachment body constructed in accordance with the invention;

FIG. 5 is a front elevation view of a second alternative cable attachment body constructed in accordance with the invention;

FIG. 6 illustrates the preferred dimensions and radii of curvatures of the cable attachment body of FIG. 5;

FIG. 7 is a front elevation view of a third alternative cable attachment body constructed in accordance with the invention and illustrated with segments of exemplary straps for coupling the body to a handle; and

FIGS. 8A and 8B are respectively back and front oblique views showing a typical handle coupled to the cable attachment of FIG. 7.

### DETAILED DESCRIPTION

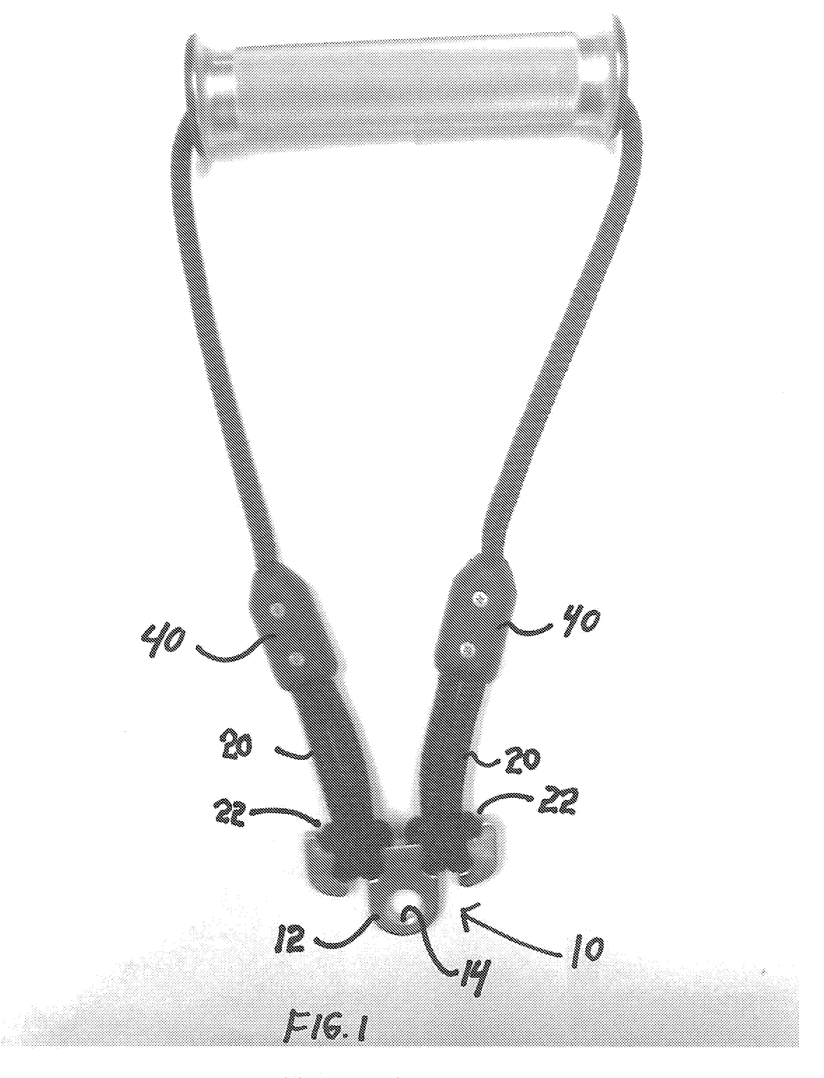

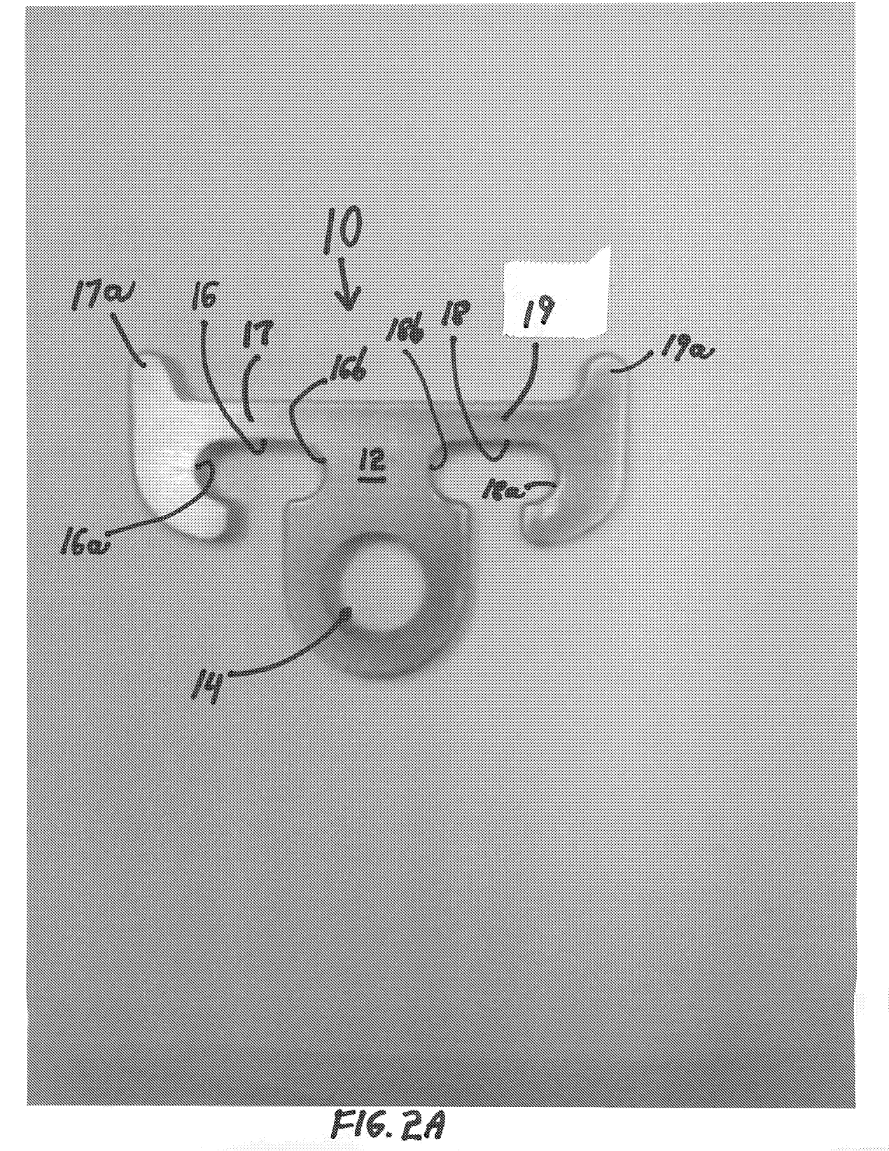

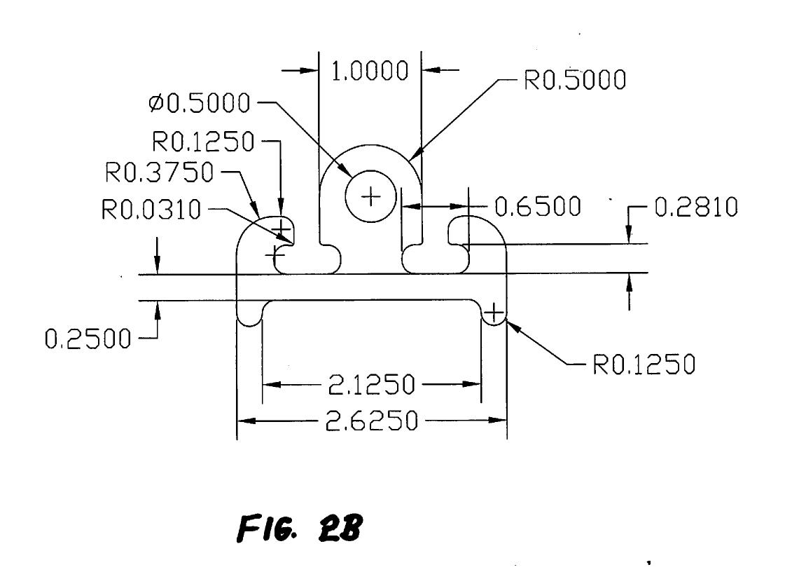

FIG. 1 is a front elevation view of a typical handle coupled to a preferred embodiment of a cable attachment constructed in accordance with the invention. FIG. 2A is a front elevation view of the cable attachment illustrated in FIG. 1. The cable attachment 10 comprises a body 12 having three juncture points arranged in a generally triangular relationship. A hole 14 near its bottom accommodates its attachment to the cable on the machine, typically via a hook or caribiner affixed to the cable.

The other two points 16, 18 lie above the illustrated hole 14, separated by the center section of the body, and are the locations to which the straps 20 are secured by a suitable knot 22. The two upper points 16, 18 are configured to resist lateral slippage of the straps and thereby laterally stabilize the load against which the user is working. In the embodiment illustrated in FIGS. 1 and 2, points 16, 18 are regions defined by respective arms 17, 19 that extend laterally outward from the body 12. The upper surface of each arm terminates in a respective tang 17a, 19a that prevent the strap from sliding laterally outward (as illustrated in FIG. 1). The bottom surface of each arm terminates in a curved hook that defines a semi-enclosed region having respective side walls 16a,b, 18a,b that, as illustrated in FIG. 1, prevent lateral movement of the strap 20 to the left or right. The arms 17, 19, tangs 17a, 19a and curvatures of the arms keep the strap in position when different angles of force are applied by the person exercising. Sharp edges are avoided to avoid cutting or wearing of the strap material. FIG. 2B illustrates the preferred dimensions and radii of curvatures.

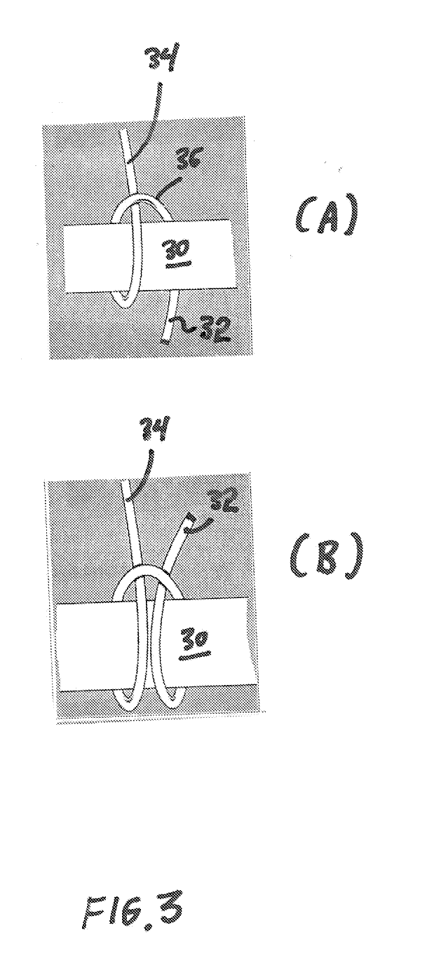

Insofar as knots are concerned, one should use a knot that provides good security against unintended slippage, lends itself to as uncomplicated and easy untying as practical, and does not detract from the appearance of the device if possible. While there are numerous knots that can be used, and the invention is not limited to any particular kind of knot or fastener, the currently preferred knot is the cow's hitch which meets all of the foregoing specifications. FIGS. 3A-B illustrate the formation of a cow hitch knot. In FIG. 3A, the working end 32 of the strap is draped over the front of a structural member 30, and passed around the back of the member 30 on the left side of the standing portion 34. The working end 32 is then brought up the backside of the member 30, across the standing portion 34 to form a loop 36, and around the back of the body 30. Then, as illustrated in FIG. 3B, the working end 32 is passed upward around the front of the member 30 and pulled through the loop 36. The standing portion and working end are then pulled tight to complete the knot.

Other knots are suitable as well. One such knot is the cats-paw, which is very similar to the cow hitch except for an additional twist on each side of the loop that can make it even less prone to slippage.

The preferred strap is a rope or cord formed from a material used in high quality rock-climbing ropes so that the strap is not prone to stretching, is very abrasive-resistant and has the tensile strength sufficient to handle the amount of stress to which it will be subjected.

To further secure the knot, it is preferable to further clamp the working end of the strap to a standing part as a precaution. Briefly, the “working end” of a rope is the term conmonly used to refer to the part of a rope that is active in knot tying, while the term “standing part” is the part not active in knot tying. These terms are relative, but the meaning herein is evident in the context of the description and drawings herein. In the preferred embodiment, the clamp used is the E-Z TY® rope clamp manufactured by Shell Engineering, Inc. (San Marcos, Calif.). The clamp additionally hides and protects the working end of the strap while providing additional strength and safety.

When the strap needs to be replaced, the clamp (if used) is easily undone with a screwdriver . . . the most common tool in people's possession. The knot is then easily undone, and the strap is pulled from the handle and replaced with a new strap that is then coupled and knotted to the body of the cable attachment and clamped (if a clamp is used).

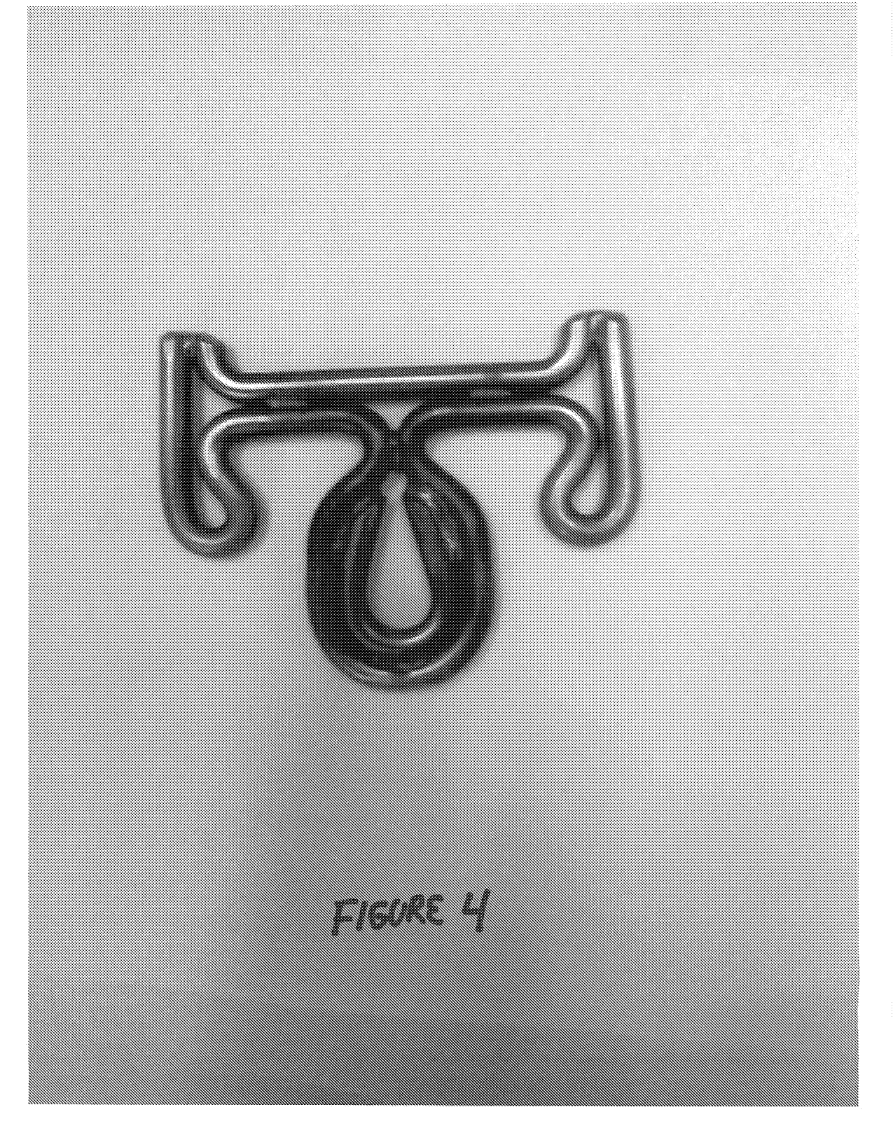

The body 12 can be laser cut, formed with a waterjet or abrasivejet cutting head, or stamped from flat stock that is preferably approximately 3/16″ thick or more. Alternatively, the body can be formed from small round rod approximately 3/16″ in diameter that is bent into the desired shape, as illustrated by way of example in FIG. 4.

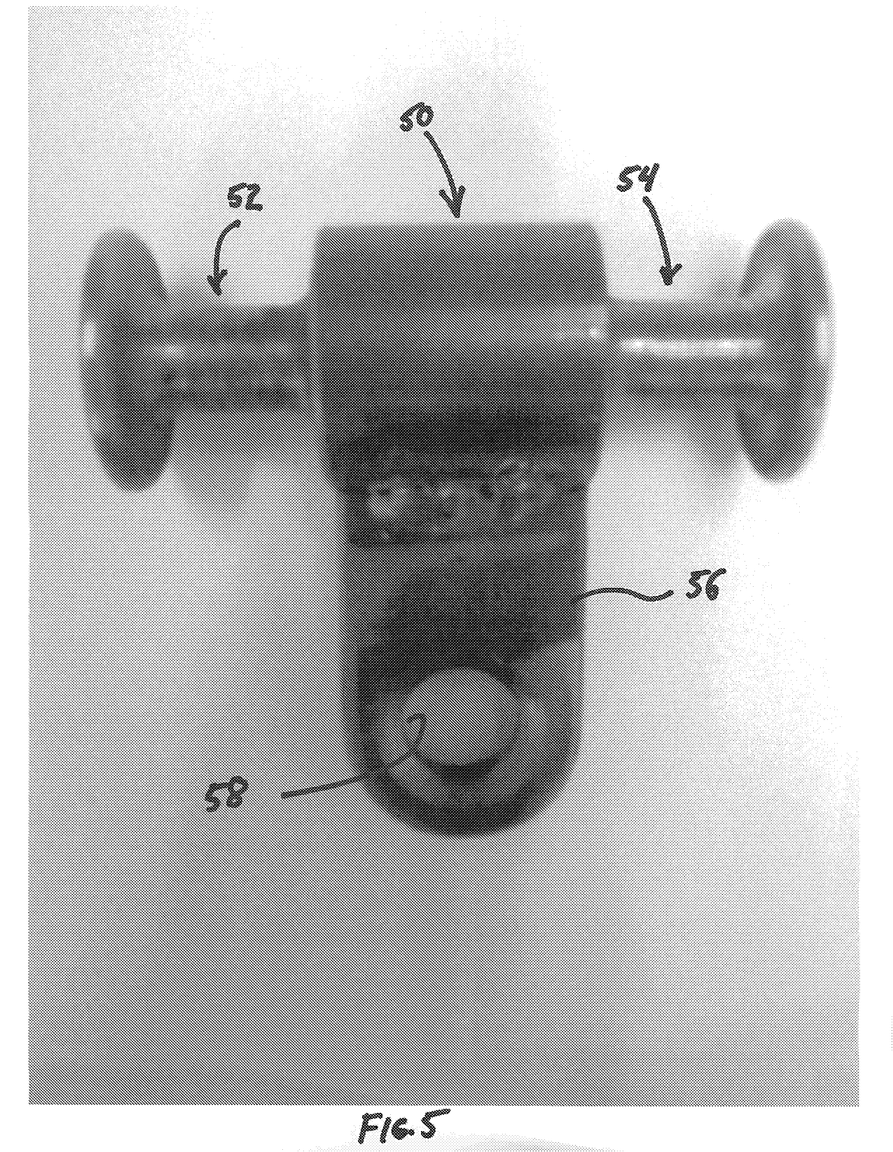

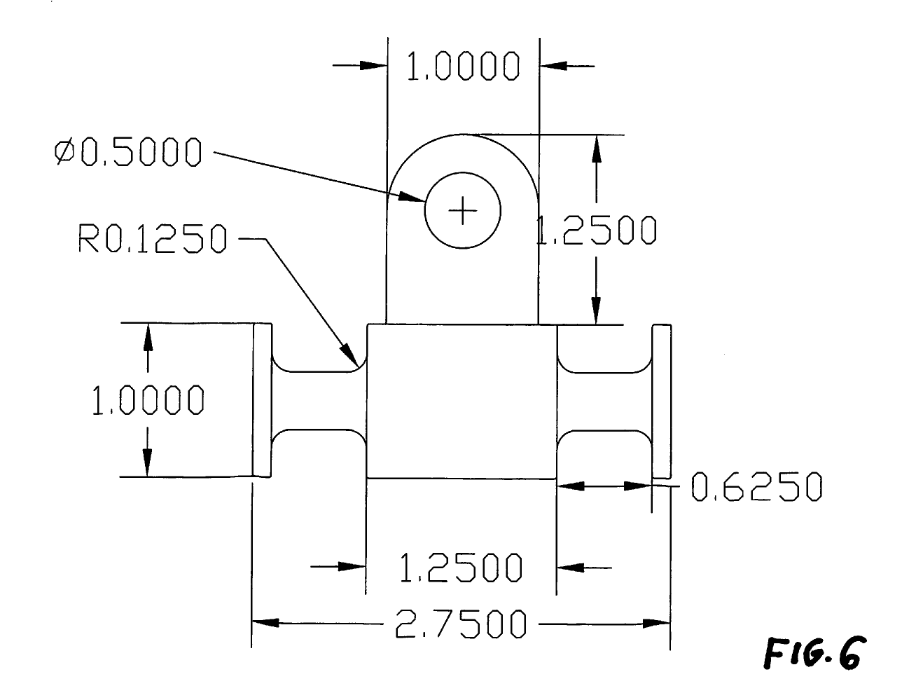

FIG. 5 is a front elevation view of a second alternative cable attachment body constructed in accordance with the invention. The body is machined from a solid round steel rod 50 having a preferred diameter of approximately ¾ inch to 1 inch. The strap-guiding functions of the tangs and wall-defining curvatures of the preferred embodiment are instead provided by two grooves 52, 54 cut into respective end regions of the rod. The straps are attached to the rod within respective grooves, using a knot as in the preferred embodiment. The side walls of the groove prevent the straps from sliding off the rod. A center post 56 is welded or otherwise affixed securely to the rod for attachment to the cable machine via a hole 58 in the post 56. FIG. 6 illustrates the preferred dimensions and radii of curvatures of the cable attachment body of FIG. 5.

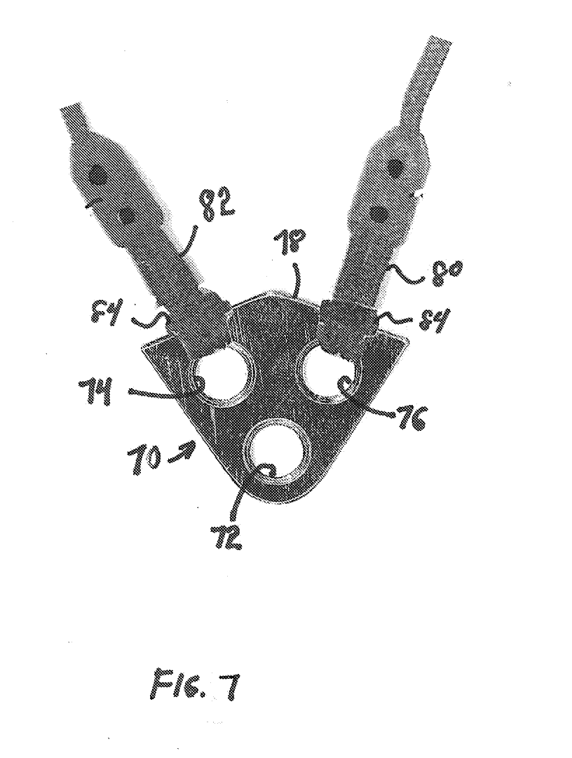

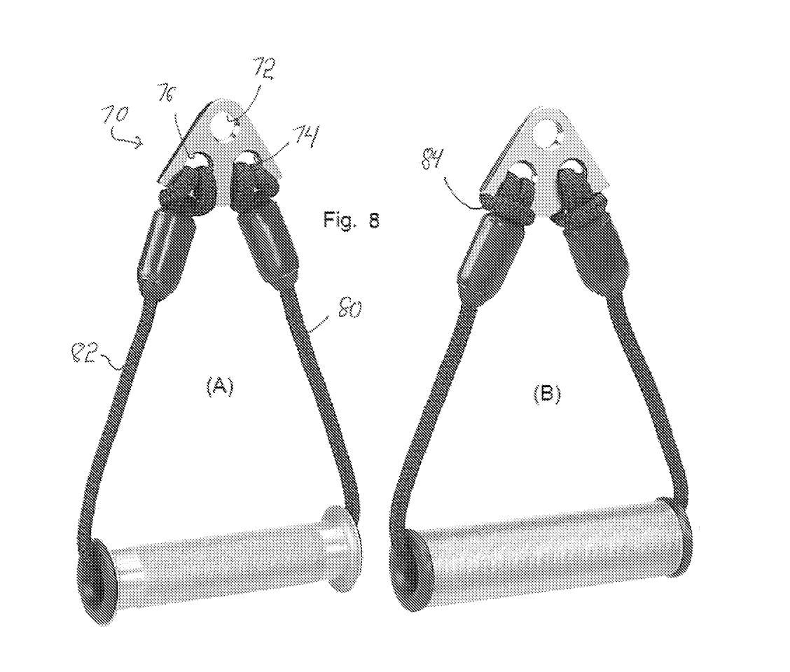

FIG. 7 is a front elevation view of a third embodiment of a cable attachment body constructed in accordance with the invention. FIGS. 8A and 8B are respectively back and front oblique views showing a typical handle coupled to the cable attachment of FIG. 7.

Referring to FIG. 7, the cable attachment body 70 is preferably ⅛ inch to 3/16 inch thick and has three juncture points 72, 74, 76 in the from of respective through-holes 72, 74, 76 extending through the body between front and rear faces. The holes 72, 74, 76 are arranged in a generally triangular relationship, the first hole 72 being near the bottom of the body to accommodate the body's attachment to the cable of an exercise machine. The other two holes 74, 76 are located above the first hole and separated from each other by the center section of the body. The holes 74, 76 securely accommodate a removably-coupled handle-coupling strap, preferably via a suitable knot, such as the preferred cow hitch type knot previously illustrated and described. The interior walls of the two holes 74, 76 resist lateral slippage of the straps in order to laterally stabilize the load against which the user is working.

The top of the body 72 is preferably characterized by a top surface that slants downward from the middle of the body as it extends towards the sides. The angle permits the top of the body to extend generally perpendicular to the straps 80, 82 that extend from the handle. This provides a good seat for the knot because the slanted surface of the body is generally parallel to the knot's loop 84, and also minimizes lateral slippage of the straps and thereby laterally stabilizes the load against which the user is working.

Thus, the preferred angle of the slant is a function of the angle made by the straps with the vertical which, in turn, depends on the distance of the handle from the body 70 when the straps are fully extended, and the distance between the two straps as they leave the handle. In practice, a slant of 30 degrees (with respect to the horizontal direction in FIG. 7) appears to accommodate the handles and handle distance used by the inventors.

In some cases, gym owners and others will wish to avoid the use of easily disassembled handle/attachment assemblies owing to liability concerns if users, for example, can easily take the assembly apart without securely re-assembling it. Accordingly, those of ordinary skill in the art will recognize that clamps can be used that are not easily disassembled (as are the clamps 40 in FIG. 1), and that clamps requiring special tooling or destructive removal may be used instead without departing from the scope of the invention. In such cases, replacement of the straps can be limited to authorized personal, while still preserving the handles and simply replacing the straps and any destructively removed clamps.

It is understood by those of ordinary skill in the art that the shapes, dimensions, clearances and tolerances recited herein may vary to comply with specifications and appearances determined by designers and manufacturers of exercise equipment utilizing cables, and may accordingly be varied by designers and manufactures of such equipment and components for such equipment without departing from the scope of the invention.

Although a preferred embodiment and two alternative embodiments of the present invention and its advantages have been described in detail above, it should be understood that various details, changes, substitutions and alterations will be apparent to those of ordinary skill in the art having the benefit of the foregoing specification. It is intended that all such variations be within the scope and spirit of the invention, and that the invention be solely defined by appended claims that shall be given the broadest allowable interpretation consistent with the Doctrine of Equivalents.

We claim:

1. A cable attachment for an exercise machine of the type employing a cable and comprising:
a body having three juncture points arranged in a generally triangular relationship, the first juncture point being relatively distal to the other two junction points to accommodate the body's attachment to the cable of the exercise machine, the second and third juncture points lying proximal to the first junction point and laterally separated from each other by the center section of the body, said the second and third junction points being configured to securely accommodate a removably-coupled handle-coupling strap.

2. The cable attachment of claim 1 wherein the body includes a pair of through-holes respectively functioning as said second and third junction points.

3. The cable attachment of claim 2 wherein the body includes a third through-hole functioning as the first junction point.

4. The cable attachment of claim 1 wherein the proximal edge of the body comprises a pair of laterally-extending surface segments proximal to respective ones of said second and third junction points that slant distally towards respective sides of the body.

5. The cable attachment of claim 4 wherein the respective angles of the slants are such that the laterally-extending segments will be generally perpendicular to the accommodated straps.

6. The cable attachment of claim 1 including a pair of handle-coupling strap segments secured to the second and third junction points, respectively, via a respective knot.

7. The cable attachment of claim 6 wherein the knot is a cow hitch.

8. The cable attachment of claim 6 wherein at least one of the strap segments includes a standing part and a working end, and further including a clamp that clamps the working end to the standing part.

8. A cable attachment for an exercise machine of the type employing a cable and comprising:
a body having three holes arranged in a generally triangular relationship, the first hole being relatively distal to the other two holes to accommodate the body's attachment to the cable of the exercise machine, the second and third holes proximally spaced from the first hole and laterally separated from each other by the center section of the body, said the second and third junction points being configured to securely accommodate a removably-coupled handle-coupling strap;
a generally tubular handle having an internal through-passage for accommodating a strap;
a strap extending through the through-passage of the handle and terminating in opposite end portions, each end portion of the strap passing through a respective one of said other two holes and being secured therein to the body via a respective knot.

9. The cable attachment of claim 8 wherein the strap extends from a standing part region, passes through the knot, and terminates in a working end portion, and wherein the cable attachment includes a clamp for securing the working end portion of the strap to the standing part region the strap.
